(19) United States
(12) Patent Application Publication
(10) Pub. No.: US 2009/0222517 A1
(43) Pub. Date: Sep. 3, 2009

(54) Methods, systems, and apparatus for using virtual devices with peer-to-peer groups

(76) Inventors: Dimitris Kalofonos, Cambridge, MA (US); Zoe Antoniou, Belmont, MA (US)

Correspondence Address: Hollingsworth & Funk, LLC, 8009 34th Avenue South, Suite 125, Minneapolis, MN, 54425, US

(21) Appl. No.: 12/074,119

(22) Filed: Feb. 29, 2008

(51) Int. Cl. G06F 15/16

(52) U.S. Cl. 709/204

(57) ABSTRACT

Using virtual devices with P2P groups involves sending a discovery record from a virtual device to an Internet-based broker. A registration message from the peer-to-peer group is received by the virtual device in response to the discovery record. The registration message is used to join the virtual device with the peer-to-peer group. The user is authorized via the Internet-based broker and the virtual device is joined with the peer-to-peer group based on the user authorization and the registration message. Services are then provided to the peer-to-peer group via the virtual device in accordance with the discovery record. The virtual device may include a wide-area network service that is modeled to act as a physical device of the peer-to-peer group.

### FIELD OF THE INVENTION

This invention relates in general to computer networks, and more particularly to adapting existing network service infrastructures to operate in personal/social peer-to-peer networks.

### BACKGROUND OF THE INVENTION

Internet Consumer Services are increasingly gaining in popularity and market share. Examples include online music, video rentals, photo printing, gaming, shopping, etc. Furthermore, new forms of such services have appeared recently, such as personal networking services (e.g. online storage and backup of user's files, remote connectivity to home computers) and, most notably, social networking and online communities.

The current paradigm, common to all of these services, is that of centralized web-based user interaction. According to this paradigm, a user typically registers for a service (either for free or for a monthly fee) and then he/she gains access to the service provider's infrastructure over the web, which stores or offers for download/streaming all related content and services necessary to the users. In the case of social networking sites, a number of users create communities to interact and share content online by accessing a centralized web-site, which acts as a central repository that exposes the resources that each user uploads to share with the community.

The web-based paradigm of Internet Consumer Services, although very successful, has some limitations. For example, a typical user may have to sign-up to dozens of different web-sites and services to be able to receive the services needed in his or her daily life. For example, a user may need a Flickr™ account for photo printing, an AT&T™ account for online backups, a Facebook™ account for social interaction, a Google™ account for email, an iTunes™ account for music, a NetFlix™ account for video rentals, a Linksys™ dynamic DNS account for remote access to the home Linksys™ Wi-Fi camera, an Amazon™ account for online shopping, a Nokia™ account for maps and navigation, and so on. This creates “sign-up fatigue” because users are increasingly inconvenienced every time that they have to repeat a registration process in order to access a new service. In some cases, this also means they add-up the number of service providers to whom they pay monthly fees, which creates further inconvenience (e.g. a lost credit card may require the user to update payment information in many different web-sites).

Single sign-on systems (e.g. Microsoft's Passport™) have failed to address this problem and gain universal acceptance for a number of reasons. Such systems take away power from service providers, and as such those providers are reluctant to embrace such systems. Further, service providers still need to collect profile information to serve their users; therefore, even if the issue of username/password is solved, users still have to repeatedly register and create many accounts and forms of payments. Also, some users may be distrustful a single entity wielding so much influence among providers, as well as concentrating so much detailed users account data with one entity.

Service and product aggregation sites, such as Amazon™ and Yahoo!™, they have created online mega-stores by aggregating 3rd party services and products. However, these sites still serve a focused type of Internet interaction with users, e.g. online shopping. Serving a wider-variety of services (e.g. social networking, music, online games, online rentals) is challenging for many reasons. For example, a Web-based interface may not yield the optimal user experience in all cases. The user's own personal devices, content, and services are typically not integrated as part of such offerings. Also, this model of aggregation does not seem to adapt fast enough to changing consumer habits.

Whatever the underlying reasons, the fact remains that people today still need to sign-up for numerous Internet consumer services on a regular basis. Further, highly-centralized, single sign-up solutions have not been effective in solving this problem. Therefore, a solution to the dilemma of sign-up fatigue that does not require access to centralized entities is desirable.

### SUMMARY OF THE INVENTION

To overcome limitations in the prior art described above, and to overcome other limitations that will become apparent upon reading and understanding the present specification, the present invention discloses a system, apparatus and method for using virtual devices with P2P groups. In one embodiment, a method involves sending a discovery record from a virtual device to an Internet-based broker. A registration message directed to the virtual device is received in response to the discovery record. The registration message is used to join the virtual device with the peer-to-peer group. The user is authorized via the Internet-based broker, the virtual device joins with the peer-to-peer group based on the user authorization, and a service is provided to the peer-to-peer group via the virtual device.

In more particular embodiments, the discovery record may be configured for use in a peer-to-peer group that may include a plurality of devices of a user that are accessed based on decentralized permissions that collectively govern access to the plurality of devices. The virtual device may include a wide-area network service that is modeled to act as a physical device of the peer-to-peer group. In other arrangements, the discovery record is modified with routing data that enables Internet access to the virtual device. In such a case, the modified discovery message may be sent to the peer-to-peer group from the Internet-based broker. Also in this case, the routing data may include an address of a routing server that maintains mappings for a plurality of virtual, and/or the routing data may enable access to the virtual device through a network firewall.

In other more particular embodiments, the services provided via the virtual device include an Internet consumer service of a third party that is independent of the peer-to-peer group and a provider of the virtual device. In such a case, the Internet consumer service may include an advertising service that delivers advertising to the peer-to-peer group. Also in such a case, a plurality of Internet consumer service may be presented as a single service of the virtual device.

In other more particular embodiments, the method further involves utilizing local services of the peer-to-peer group by the virtual device. The method may also involve sending an invitation request from the peer-to-peer group to the Internet-based broker. The invitation request is targeted to invite a second user to join the peer-to-peer group. In response to the invitation, an invitation code is received, and the invitation code is sent to the second user. The second user is authenticated via the Internet-based broker based on the invitation code, and a user device of the second user is joined with the peer-to-peer group based on authentication of the second user. The user device of the second user may join the peer-to-peer group via the virtual device. In another variation, joining the user device of the second user involves joining a second peer-to-peer group of the second user to the peer-to-peer group. In such a case, devices of the second user are accessed within the second peer-to-peer group based on second decentralized permissions that collectively govern access to the devices of the second user.

In another embodiment of the invention, an apparatus includes a network interface capable of Internet communications with a peer-to-peer group that comprises a plurality of devices of a user that are accessed based on decentralized permissions that collectively govern access to the plurality of devices. A processor is coupled to the network interface, and memory coupled to the processor. The memory includes instructions that cause the processor to send a discovery record to an Internet-based broker. The discovery record is configured for use in the peer-to-peer group and describes a virtual device provided by the apparatus. The virtual device includes a wide-area network service that is modeled to act as a physical device of the peer-to-peer group. The instructions cause a registration message directed to the virtual device to be received from the peer-to-peer group in response to the discovery record. The registration message is used to join the virtual device to the peer-to-peer group. The apparatus authorizes the user via the Internet-based broker, joins the virtual device to the peer-to-peer group based on the user authorization, and provides a service to the peer-to-peer group via the virtual device.

In another embodiment of the invention, an apparatus includes a network interface capable of communicating with a peer-to-peer group that comprises a plurality of devices of a user that are accessed based on decentralized permissions that collectively govern access to the plurality of devices. A processor is coupled to the network interface and memory is coupled to the processor. The memory includes instructions that cause the processor to join the apparatus to the peer-to-peer group and facilitate the addition of a virtual device to the peer-to-peer group. The virtual device includes a wide-area network infrastructure service that is modeled to act as a physical device of the peer-to-peer group. The instructions further cause the processor to authenticate the apparatus for access to the virtual device via an Internet-based broker that is independent of the virtual device, and access a service of the virtual device based on a user interaction with the virtual device via the apparatus.

In more particular embodiments, the instructions further cause the processor to send an invitation request to the Internet-based broker, wherein the invitation request is targeted to invite a second user to join the peer-to-peer group and receive an invitation code in response to the invitation The invitation code is sent to the second user to enable a user device of the second user to join with the peer-to-peer group based on authentication of the second user with the invitation code.

In another embodiment of the invention, a computer readable storage medium has instructions stored thereon that are executable by a processor to: a) send a discovery record from a virtual device to an Internet-based broker, wherein the discovery record is configured for use in a peer-to-peer group that comprises a plurality of devices of a user that are accessed based on decentralized permissions that collectively govern access to the plurality of devices, and wherein virtual device comprises a wide-area network service that is modeled to act as a physical device of the peer-to-peer group; b) receive a registration message from the peer-to-peer group directed to the virtual device in response to the discovery record, wherein the registration message is used to join the virtual device to the peer-to-peer group; c) authorize the user via the Internet-based broker; c) join the virtual device to the peer-to-peer group based on the user authorization; and d) provide a service to the peer-to-peer group via the virtual device

In another embodiment of the invention, an apparatus includes means for engaging in communications with a peer-to-peer group that includes a plurality of devices of a user that are accessed based on decentralized permissions that collectively govern access to the plurality of devices. The apparatus includes a virtual device module that includes a wide-area network service that is modeled to act as a physical device of the peer-to-peer group. The virtual device module includes: a) means for sending a discovery record an Internet-based broker, wherein the discovery record is configured for use in the peer-to-peer group; b) means for receiving a registration message from the peer-to-peer group directed to the virtual device in response to the discovery record, wherein the registration message is used to join the virtual device to the peer-to-peer group; c) means for authorizing the user via the Internet-based broker; d) means for joining the virtual device to the peer-to-peer group based on the user authorization; and e) means for providing a service to the peer-to-peer group via the virtual device.

In another embodiment of the invention, a method involves adding an ad software component in middleware utilized by devices a peer-to-peer group. The ad software receives ads from an ad server and distributes the ads to devices of the peer-to-peer group based on data replication mechanisms of the peer-to-peer group. In a more particular embodiment, the peer-to-peer group includes a virtual device of that manages interactions between the ad software components of the devices of the peer-to-peer network. The virtual device may receive the ads from the ad server and distribute the ads to the peer-to-peer group. The virtual device may further gather ad usage data from the peer-to-peer network and provide the ad usage data to the ad server. The method may further involve awarding a user of the P2P group credits for accessing the ads and/or for sharing the ad services with contacts to which the user has provided access to the peer-to-peer group.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIGS. 1-2 are block diagrams illustrating architecture features according to embodiments of the invention;

FIGS. 3-4 are a block diagrams illustrating interactions between virtual devices of personal device clusters according to embodiments of the invention;

FIG. 5 is a block diagram illustrating a mapping between locally provided personal device cluster services and Internet-based services according to an embodiment of the invention;

FIGS. 6-8 are block diagrams illustrating user interfaces according to embodiments of the invention;

FIG. 9 is a block diagram of an advertising infrastructure for interacting with personal device clusters according to embodiments of the invention;

FIG. 10 is block diagram of a mobile computing arrangement according to an embodiment of the invention;

FIG. 11 is block diagram of an infrastructure service computing arrangement according to an embodiment of the invention; and

FIGS. 12-13 are flowcharts describing procedures according to embodiments of the invention.

### DETAILED DESCRIPTION OF EMBODIMENTS OF THE INVENTION

In the following description of various embodiments, reference is made to the accompanying drawings that form a part hereof, and in which is shown by way of illustration various embodiments in which the invention may be practiced. The individual drawings may use the same reference numbers to refer to the same or similar features where such features are common to different embodiments. It is to be understood that other embodiments may be utilized, as structural and operational changes may be made without departing from the scope of the present invention.

Generally, the present disclosure is related to systems, apparatus, and methods for integrating peer-to-peer (P2P) personal and social networking platforms with existing Internet Consumer Services. The result is a hybrid P2P/Internet Consumer Services platform and business model. In such a platform, users will create personal and social networks of devices, where groups of devices are collectively governed by a set of permissions that device the groups and inter-group relationships.

The relationships between devices of a P2P personal/social groups as described herein are intended to reflect personal and social relationships of the users, as opposed to the technical protocols that define current device interoperation. For example, when a user buys a mobile phone and a personal computer, the user considers such devices as extensions of his/her own personal space, and as such the user has a pre-existing idea of how devices should interact. For example, the user might expect that personal content of interest to be freely available for use by all of the user's devices without significant effort on behalf of the user, and without having to deal with data and/or protocols that are not of interest to the task at hand. In contrast, current systems are vendor and/or protocol driven. As such, device interactions require specialized vendor software that may only be usable on certain platforms and devices and for certain functions. On the other hand, general computer-use paradigms (e.g., file transfer between file systems) may achieve the desired results without special software. However, these computing paradigms do not always reflect the way users view the content/services, and therefore can be confusing for average users to master (e.g., file system hierarchies often cause user confusion).

One increasingly common computing task is the access of consumer content and services via the Internet. Such content/services may be user-generated (e.g., in the case of photo printing or social networking) or relate to purchases/rentals from service providers for personal consumption (e.g., online music, video rentals). Where a user-generates content of interest, the user may need to upload the content to a server using whatever methods the service provider has created for this purpose. This can be particularly cumbersome, especially in cases when such content is generated frequently (e.g. photos, videos). Furthermore, services provided by the personal devices themselves (e.g. live video from a home Wi-Fi camera) can rarely be integrated in such service offerings. The Web-based, centralized paradigm of Internet services requires users to take several extra steps and sometimes assume expenses to make such content accessible to others, even though their content or services are already available in their network-enabled personal devices.

In the case where users wish to access products/services via a network for personal use, the users may have to download the purchased content every time they want to consume it in different personal devices. Besides being inconvenient, this may sometimes be made impossible by Digital Rights Management (DRM) systems. Often, in order to enforce DRM restrictions, service providers place artificial limits on the number of times the purchased content can be downloaded or copied to different personal devices. The intent in such a case is to limit the content distribution on this one user/subscriber.

Recently, a number of technologies in peer-to-peer (P2P) networking have been developed which will enable a decentralized P2P paradigm of social networking. In this paradigm, users will be able to easily organize their resources (e.g. devices, services, content, contacts) to form personal networks, and use these to interact and share with other people's personal networks. In contrast to the centralized networking model, this paradigm relies on no central repository that exposes the resources of each user to the community. Instead, content and services are exposed directly by the user's own devices, often in real-time as they are created.

An example of how this P2P networking operates at the lower-levels is exemplified by the Unmanaged Internet Architecture (UIA). The UIA is an architecture for zero-configuration connectivity among mobile devices through personal names. Users assign personal names through an ad hoc device introduction process requiring no central allocation. Once assigned, names bind securely to the global identities of their target devices independent of network location.

The UIA provides strong permanent location-independent device identifiers, and allows users to securely bind personal names to devices. Each device creates a unique public/private key pair, and hashes the public key to create an endpoint identifier (EID), which acts as the permanent device address. UIA constructs an overlay network and offers a traditional socket API to establish connections. The UIA router forwards connections over the authenticated and encrypted overlay network to the destination.

The UIA is one example of a distributed services middleware that provides basic network connectivity and discovery capabilities. Another architecture, which will be referred to herein as “MyNet,” can build on top of this type of P2P middleware to create a secure decentralized P2P paradigm of personal and social networking services aimed at non-expert consumers. MyNet can be built on top of other P2P technologies besides UIA, however, two UIA capabilities already meet MyNet overlay network requirements: ubiquitous connectivity and distributed device group management. UIA's routing overlay supports IP mobility along with seamless operation though NATs and most firewalls. UIA's authenticated mappings from device EIDs to group and user identifiers (SIDs) can provide the basis of authorization queries in that MyNet security framework. A conventional approach of an authenticatable User ID derived from a user private/public key pair could also be followed.

MyNet users are able to easily organize their personal resources (e.g., devices, services, content, social contacts) to form personal networks, and use these to interact and share securely with other people's personal networks. In the MyNet P2P paradigm, in contrast to the centralized web-based one, there is no central repository that exposes the resources of each user, but content and services are exposed directly by the users' own devices, often in real-time as they are created. To achieve all this, MyNet offers a comprehensive security and service management framework, and a very intuitive user experience, which allows non-expert users to perform personal and social networking tasks that today are only possible by computer and networking experts. MyNet distributed applications that leverage MyNet's unique functionality (e.g., service management, security, user interface tools) through the use of MyNet Application Programming Interfaces (APIs) are called MyNet-“aware” services.

In the MyNet framework, personal content and services are exposed by distributed applications running on user's devices, which all appear to be connected and running over the same secure virtual personal network. This secure personal network is referred to herein as a Personal Device Cluster (PDC). To date, MyNet has been a purely P2P system connecting only users' personal devices (e.g., mobile phones, PDA, music players, game consoles, PCs, DVRs), and allowing pervasive access and sharing of content and services contained therein. Integrating MyNet's unique features of seamless access, security and ease-of-use with existing Internet Consumer Services, would create a new hybrid P2P/Internet Consumer Services paradigm, which would leverage the strength of both approaches, while addressing some of their inherent limitations. This disclosure addresses this and other improvements to known Internet Customer Service approaches.

In various embodiments of the invention, a system integrates P2P personal and social networking platforms such as MyNet, with existing Internet Consumer Services. The result is a hybrid P2P/Internet Consumer Services platform and business model. The following illustrative use case provides an example of how the system as described here will appear to users. James has a PDC with three devices: a mobile phone, a Personal Computer (PC) and a Digital Video Recorder (DVR). Using his PC, James signs up for a MyNet Virtual Device (MVD). The MVD may be any combination of a service offered by a locally or remotely situation apparatus that is provided by a commercial service provider. The MVD appears to the user just as one of his local devices (e.g., a second PC) but does not require the purchase and/or installation of a piece of hardware by the end user.

In this example, the MVD provides James with free backup storage and a number of optional services. The MVD appears as an icon in a viewer application that allows James to see his other devices (e.g., mobile phone and DVR). Underneath the MVD icon is an icon representing a MyNet music service. James clicks on the MyNet music service icon which automatically launches the installation wizard. The music service is installed with a GUI customization for the PC device. James can now build his playlist, both from songs he has stored on his DVR and from songs he purchases online through the music service.

Next, James switches to his mobile phone and clicks on the MVD music service, which launches the installation wizard with a customized GUI for the phone display. The songs on the playlist he built on his PC are now available to all his PDC devices, including his mobile phone. The music service allows James to give a limited number of permissions objects (referred to herein as “Passlets”) for songs he has already purchased. A streaming Passlet allows the recipient to stream the song free of charge on one instance. Using his phone, James gives a streaming Passlet to his friend Peter for the latest hit “Crazy” he recently bought. Peter listens to the song and decides to buy and download it for himself.

Among the advantages offered to the user by such a MyNet-“aware” Internet Service are: (a) ease-of-use, convenience, click-of-a-button user experience, because the MyNet P2P overlay makes sure that the MyNet-“aware” Internet Services have access to all of the user's personal resources; (b) optimized user-interaction through the use of MyNet-“aware” client-side applications to the MyNet Internet Services installed automatically or on demand to the user's personal PDC devices; (c) no need to register separately for every new MyNet Internet Service, thereby enabling one-stop shopping for a wide variety of Internet Consumer Services; and (d) social networking aspects, as user's will be able to use MyNet's functionality to identify and give permissions (Passlets) to any of their social contacts to share functionality that is allowed by each MyNet-“aware” Internet Service.

### Background: Existing P2P MyNet Introduction Process

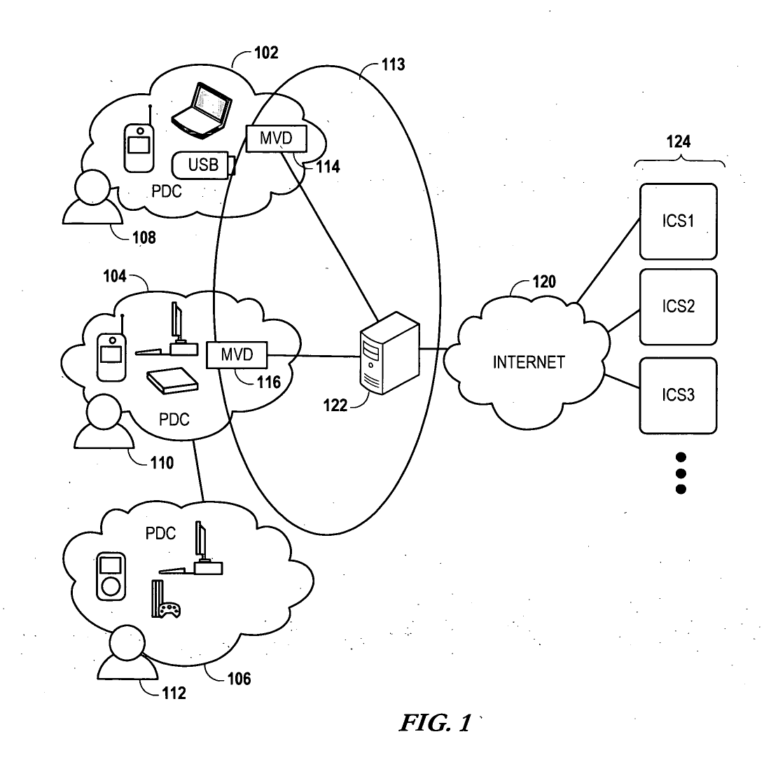

In reference now to FIG. 1, a block diagram illustrates some features of a MyNet P2P networking architecture according to embodiments of the invention. A new device becomes a MyNet device through an imprinting process, which imprints the owner identity, profile and secret (e.g. PIN). The owner secret offers protection against misuse for critical tasks, such as adding/deleting a personal device. The user can also set preferences about which other actions, e.g. adding a social contact or granting permissions, are protected by this secret. The imprinting process uses the available platform User Interface (UI) modalities, such as graphical user interfaces (GUI) and Radio Frequency ID (RFID).

Currently, MyNet allows non-expert users to create secure personal overlay networks of their MyNet devices called Personal Device Clusters (PDCs). The PDC is the basic cell of a MyNet network. It is the Personal Network of a user and all devices in it can authenticate themselves as being part of the same PDC, thus allowing privileged access to each other. The process of creating a PDC involves the user bringing a new device in physical or local network proximity with any of his already bootstrapped MyNet devices and manually performing what is called the P2P MyNet Introduction process. This process is based on exchanging security credentials and connectivity information (e.g. via UIA). After the Imprinting and Introduction processes, all devices in the PCD can authenticate themselves as being part of the same PDC, no further user interaction is needed to enable this authentication. Example PDCs are represented in FIG. 1 by reference numbers 102, 104, and 106.

The user/owner of an existing PDC manually authorizes via the P2P MyNet Introduction process a new device to join his/her PDC. From that moment on, the new device becomes part of the PDC and has full connectivity and secure access to the user's PDC devices, content, services, contacts, etc. A more complete description of MyNet security mechanisms is described in U.S. patent application having Ser. No. 11/848,702 filed on Aug. 31, 2007 and entitled “Apparatus and Method for Managing Access to One or More Network Resources” (hereinafter referred to as “MyNet Security”).

Furthermore, the user can use the same P2P MyNet Introduction process to initiate the creation of a social link from his/her PDC to another user's PDC. This requires each of the two users, whose PDCs will be linked, to bring one of his/her PDC device in physical or local network proximity to a PDC device of the other user and perform the P2P MyNet Introduction process, which again may be based on existing methods of exchanging security credentials and connectivity information (e.g. using UIA mechanisms). From that moment on, any device in one user's PDC (e.g., PDC 102 associated with user 108) can access any device, content, services, contacts in the other user's PDC (e.g., PDCs 104, 106 associated with users 110, 112) that is authorized by that other user through the MyNet security mechanism described in MyNet Security.

During MyNet social linking, the UIA layers of the two devices exchange routing information, SIDs and EIDs. Once linked, UIA and MyNet gossip takes place and the linked PDC devices know how to route overlay traffic among them. The creation of social contacts establishes long-lived trust relationships allowing users to share resources at any time. For ephemeral sharing scenarios, users may use an out-of-band mechanism to grant “Passlets” that allow temporary access.

Passlets, which resemble the real-world metaphor of “passes” or “tickets,” contain user-level permissions for its recipient. There are Device Passlets (full access to all services hosted in a device) and Service Passlets (access to selective functionality exposed by only one service). It is also possible to give “PDC-wide” Passlets for a service, i.e. grant access to all instances of the specific service running on any PDC device. In the absence of a Passlet, access to all services over the MyNet overlay is blocked by default.

### MyNet Virtual Devices

The present disclosure describes enhancements to the P2P aspects of MyNet with a centralized infrastructure and service provided by a MyNet Service Provider (MSP) 113. An MSP 113 may be any commercial or non-commercial service provider entity that provides additional components that can be added to user PDCs. According to this, an MSP 113 can choose to provide users with MyNet Virtual Devices (MVD) 114, 116 which are computers, virtual machines, or processes hosted remotely via the Internet 120 at an infrastructure controlled by the MSP 112. This infrastructure is represented by MSP backend server 122. The backend server 122, provides an interface between the PDCs 102, 104, 106 and various Internet Consumer Services (ICS) 124. The ICSs 124 may include services that facilitate content sharing, shopping, media download, and other consumer network services known in the art.

It will be appreciated that the MSP may provide MVDs 114, 116 using any combination of local or remote hardware. For example, an MSP may provide some or all MVD functionality in a ubiquitous, always-on local device such as a set top box, DVR, device recharging station, etc. Such local hardware may be able to perform some functions as Introduction of the MVD using proximity wireless communications, providing a secure firewall, enabling remote access through an existing firewall, etc. It will be appreciated that at least some portion of the MVD functionality may be retained in a backend server 122 for purposes such as ease of upgrade, reliability, availability, mobile access, etc. More commonly, it is envisioned that most or all of MVD functionality will be provided by backend servers 122.

The MVDs 114, 116 are merged in the respective user's PDCs 102, 104 via an introduction process described in greater detail hereinbelow. Even though the apparatus that provides the functionality can be located anywhere, the MVDs 114, 116 may appear to the users 108, 110 exactly the same as any of his/her other PDC personal devices. The MVDs 114, 116 include the P2P MyNet middleware, which allows them to route traffic over P2P MyNet overlay networks like any other regular MyNet device. Also, MVDs 114, 116 can run any of the distributed applications that run in the rest of the user's PDC MyNet personal devices.

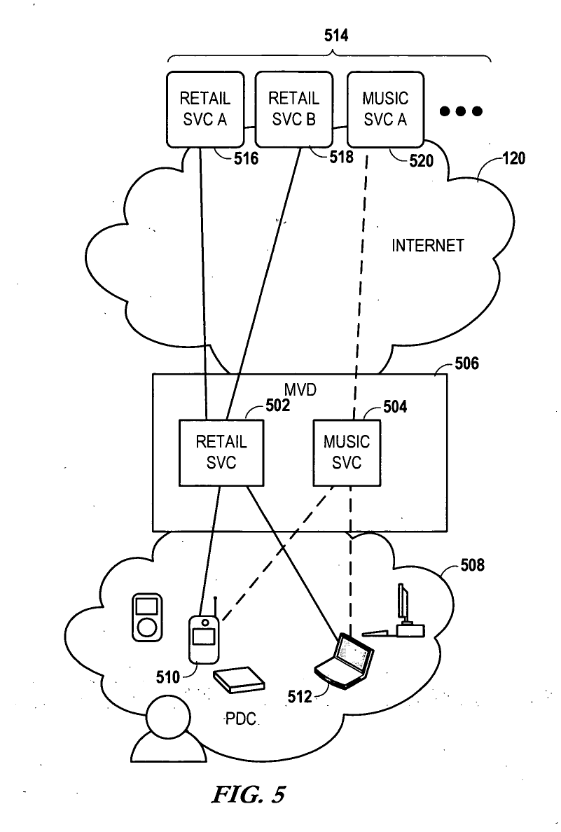

The MVD may be configured to provide special MyNet-“aware” applications running on user's MyNet devices, which is shown by way of services 210-213 running on example MVD 208. The services 210-213 may run on any of the users' MyNet PDC devices. However MyNet-“aware” Internet Services are most likely to run on MVDs, which offer 24/7 availability and infrastructure-grade reliability. The MVDs 114, 116 have a components that allow them to exchange messages (e.g., initiate remote procedure calls) with the MyNet components of PDCs 102, 104. These component are slightly different than the P2P implementations used in regular MyNet devices. As represented by user 112 and PDC 106, there will be users who can still interact in a pure P2P fashion with the rest of the MyNet users 108, 110, even without signing up for the value-added MSP services (which includes the MVDs 114, 116). As such, the MVDs 114, 116 can be introduced in a non-disruptive fashion and without negating other advantages provided by MyNet. A more detailed discussion of MyNet-“aware” Internet Services is provided below in reference to FIG. 5.

### MyNet Broker

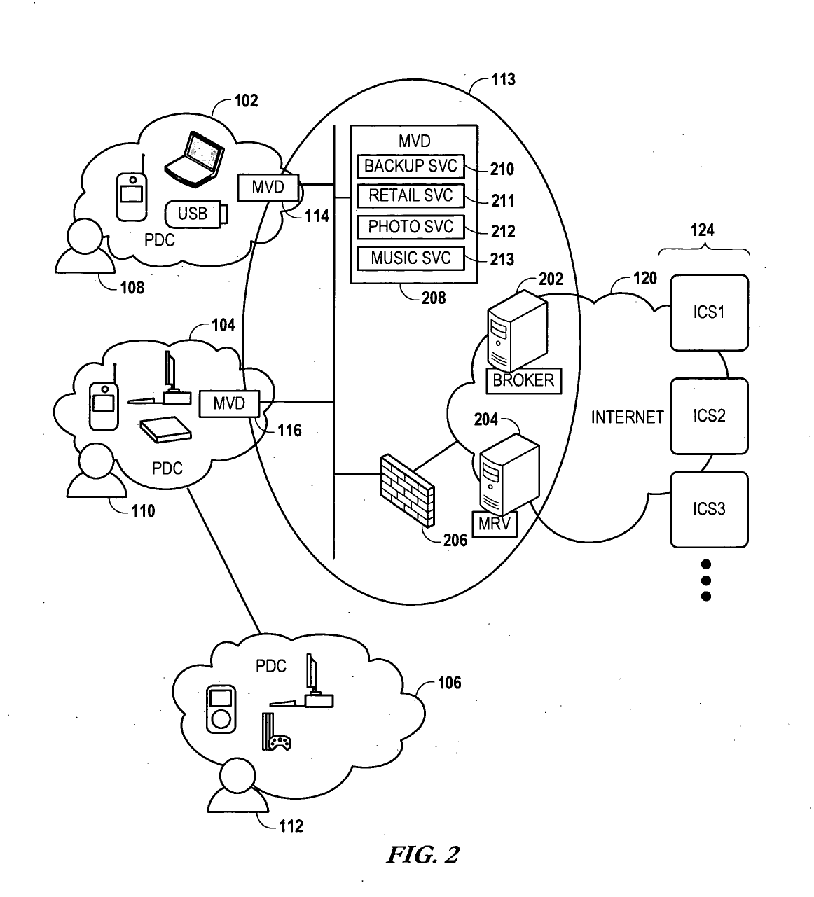

In reference now to FIG. 2, a block diagram shows more detailed description of the system architecture of FIG. 1. The Remote MyNet Introduction process describes a software component, called the MyNet Broker 202. The MyNet Broker 202 interacts MyNet middleware installed in all MyNet devices (i.e. physical MyNet devices and MVDs 114, 116 of PDCs 102, 104). The Broker 202 is a trusted centralized host controlled by the MSP 113 that communicates securely with the PDCs 102, 104 via a publicly routable IP address of the Broker 202.

The MyNet Broker 202 mediates, authenticates, and authorizes MyNet devices during the Remote MyNet Introduction process. A proposed software component in MVDs 114, 116 ensures a trusted relationship with the MyNet Broker 202, e.g., both sides can authenticate each other as Broker/MVDs in a trusted manner. A user who decides to add an MVD to his/her PDC uses the proposed software component in any of his/her PDC devices to contact the MyNet Broker 202 and register for an MVD. Again, the proposed software component on regular MyNet PDC devices makes sure that the Broker 202 is identified and authenticated in a trusted manner. No special user interaction is required to identify and build trust with the Broker 202. Once registered for an MVD, the Broker 202 gives the requesting MyNet device enough information so that it can add a trusted MVD as part of its PDC and authorizes the addition of this MVD only to that user's PDC.

The system also includes a publicly accessible node 204, referred to herein as MyNet Rendezvous (MRV). The MRV 204 stores overlay routing information that allows external entities (e.g., services 124) to access the MVDs 114, 116, which may be behind a Network Address Translation (NAT) firewall 206. The overlays may provide, for example, special IP address and port mappings that are used for secure access through the firewall 206.

### Remote MyNet Introduction Process

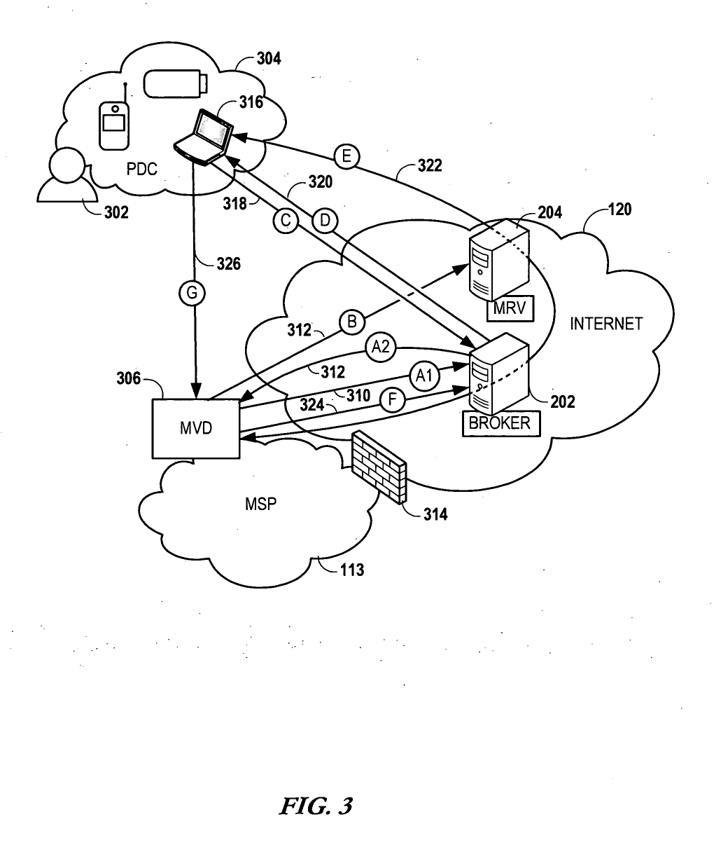

In reference now to FIG. 3, a block diagram illustrates an example of Remote MyNet Introduction Process according to an embodiment of the invention. This diagram illustrates how a user 302 of a first PDC 304 is provided with a new MVD 306 of MSP 113. After the new MVD 306 is installed to the MSP 113, it registers with a MyNet Broker 202 by sending a discovery record via path 310. The discovery record 310 is a peer devices discovery record that is used in the P2P MyNet Introduction Process and describes MVD services that are available to peers. The Broker 202 replies 311 and provides MVD 306 with overlay routing information of the MyNet overlay node 204 that has a publicly routable IP address.

The MVD 306 includes an overlay router component that uses the routing information received by the Broker 202 in response to discovery 310 to add an overlay route to the MRV 204, as indicated by path 312. This route data 312 ensures that P2P overlay traffic destined for MVD 306 can be later routed by the MRV 204, even though the MVD 306 may be behind a NAT/Firewall 314 of the MSP 113. The MSP 113 may maintain an infrastructure which includes one or more private IPv4 networks of servers that host a number of MVDs. As such, the MSP 113 may utilize the firewall/NAT 314 for security purposes and for IPv4 addressing issues

The user 302 may discover the MVD 306 in any number of ways, including: access via Web page or Internet search; software distribution by tangible media; installation of a proprietary MVD “portal” by way of MyNet middleware extensions or vendor-provided user hardware; joining of another user's PDC; etc. The user 302 can decide to use any of his/her PDC devices to register for the MVD 306, such as portable computer 316. User profile information is saved in the MyNet Broker in response to this registration message, as indicated by path 318. The registration message 318 indicates a request to join the MVD 306 with the PDC 304. Also, some security information of the user's device is also stored at this step 318 that will allow the Broker 202 to authenticate this device 316 later.

The user's device 316 receives a modified version of the MVD's discovery record via path 320. The Broker 202 has replaced the overlay routing information produced by the MVD 306 in its original discovery record, with that of the MRV 204. This will allow subsequent actions of the P2P MyNet Introduction process to be routed through the MRV 204. In particular, the user's device 316 then proceeds to send a P2P MyNet Introduction message to the MVD 306 over the overlay, as represented by path 322. The introduction messages 322 are routed over the P2P overlay by the MRV 204.

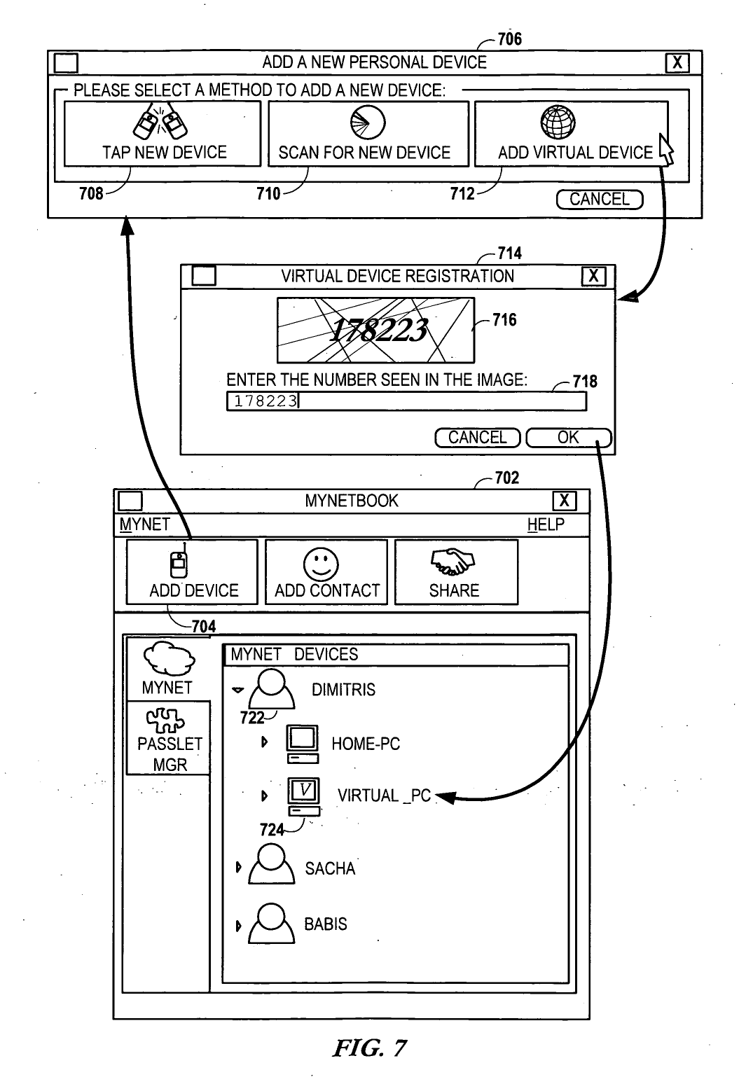

Before consenting to join the user's PDC 304, the MVD 306 requests authorization from the MyNet Broker 202, as represented by path 324. The Broker 202 checks to see if the user 302 has registered, and whether the device information matches the one stored in step 318. If everything checks, the broker 202 authorizes the merging to complete, and the MVD 306 is now part of the user's PDC 304, as represented by path 326. MyNet P2P overlay traffic can be routed from and to the MVD 306, in the same way as in all other user personal devices. The MVD 306 has all security privileges that other PDC personal devices have. It appears to the user 302 as yet another personal device in his/her PDC 304. Similarly, as with any peer of the PDC 304, the MVD 306 can utilize services of PDC devices. For example, a backup service of the MVD 306 could automatically query PDC devices for differential backup data at regular intervals, without requiring user initiation of such actions. Further details of MVD installation and registration are shown and described in relation to FIG. 7

The interactions involved in the Introduction process shown in FIG. 3 can be summarized as follows:
A1) MVD 306 registers with MyNet Broker 202 and sends an MVD discovery record to the Broker 306.
A2) Broker 202 replies with MyNet Rendezvous' (MRV) overlay routing info.
B) MVD's overlay router adds overlay route to MRV 204. This ensures P2P overlay traffic destined for MVD 306 can be later routed by MRV 204.
C) The user 302 uses one of his/her devices 316 to register for an MVD 306. User profile information is saved in MyNet Broker 202.
D) The device 316 receives MVD's discovery record modified; overlay routing information of the MVD 306 has been replaced with that of the MRV.
E) User's device 316 proceeds to the P2P MyNet Introduction process with the MVD 306 over the overlay, messages routed by MRV 204.
F) MVD 306 requests authorization from MyNet Broker 202 to merge in user's PDC 304. Broker 202 checks to see if the user 302 has registered and authorizes.
G) The MVD 306 is now part of the user's PDC 304. Overlay traffic can be routed from and to the MVD 306, same as in all other user personal devices of PDC 304.

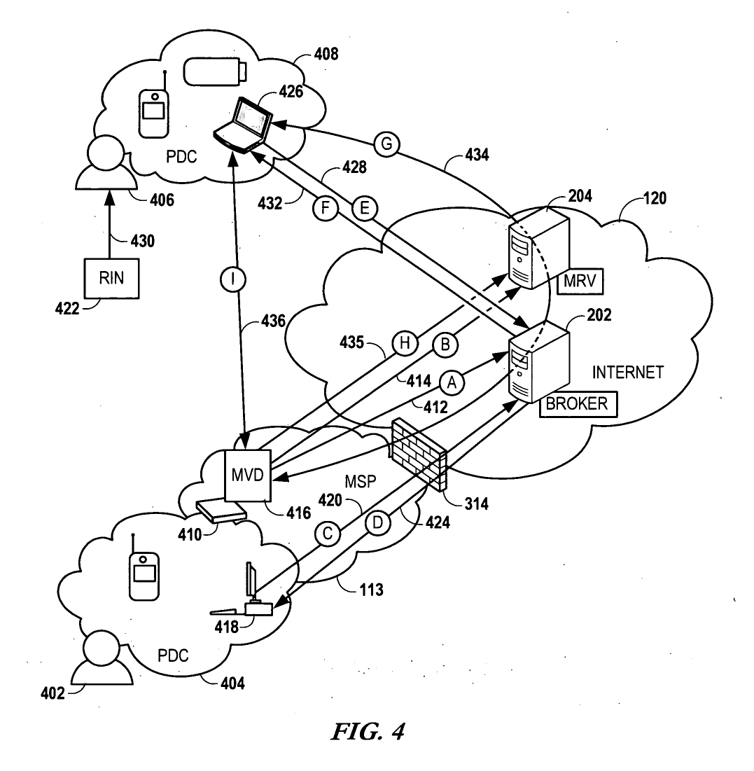

Besides adding a remote MVD 306, the Remote MyNet Introduction process includes a process for two users to add a social link between their PDCs remotely, without requiring them to be in physical or local network proximity as may be required by the P2P MyNet Introduction process. In reference now to FIG. 4, a block diagram illustrates an example scenario of this social linking process. The MyNet Broker 202 and MRV node 204 play a similar role as in the process described above in relation to FIG. 3. The ability to add social contacts remotely is another incentive for users to register for an MVD.

In the scenario of FIG. 4, user 402 having PCD 406 wishes to add a social link to user 408 (e.g., to add user 406 as a “buddy” or “contact”). User 402 uses one of his devices (e.g., set top box 410) to register with the MyNet Broker 202 as represented by path 412. During this registration 412, device 410 sends to the Broker 202 its discovery record and security information that allows the Broker 202 to authenticate any of user's PDC devices 404 as belonging to user 402. User profile information is also saved in the MyNet Broker 202 in response to this action 412.

The discovery record sent by device 410 is the peer device discovery record that is used in the P2P MyNet Introduction Process. The Broker 202 replies with the overlay routing information of the MRV 204. The device 410 includes an overlay router that uses the routing information received by the Broker 202 to add an overlay route to the MRV 204 via path 414. This ensures that P2P overlay traffic destined for device 410 can be later routed by the MRV 204, even though 410 may be behind the NAT/Firewall 314.

The registration parts 412, 414 of this process need to be performed only once, such as when user 402 first adds MVD 416 to his PDC 404. The details of this registration are described in greater detail above in related to FIG. 3. In the present example, device 410 as also includes the MVD 416. It is preferred that the MVD is added to PDC 404 before further invitations are sent, as this ensures that device 410 (thus MVD 416) will be online whenever user 406 attempts to respond to an invitation sent by user 402 as described below.

At some time after the MVD 416 is registered 412, 414, user 402 decides to send an invitation to user 406, and thereby create a social link between their PDCs 404, 408. User 402 uses any of his PDC devices (e.g. computer 418) to contact the MyNet Broker and send a request 420 for a remote invitation to be sent. The user 402 may specify an out-of-band method on how to notify user 406, such as an email address or an SMS number. The Broker authenticates device 418 as belonging to user 402 (using information provided by registration 412).

Assuming the authentication is successful, the Broker 202 allows the process to continue by creating a random number (e.g., 128-bit), which is called the Random Invitation Number (RIN) 422. The RIN 422 is sent back to device 418 via path 424. If a notification method was specified by device 418 in request 420, the Broker 202 also sends the RIN 422 with an out-of-band message 430 to user 406 (e.g., with an email or SMS). Otherwise, user 402 may communicate the RIN to user 406 by some other mechanism 430 (e.g., telephone call, post card, etc.). After communication 430 of the RIN 422 by whatever means, the Broker 202 adds an entry that corresponds to the RIN 402 to an internal invitations database.

At a time after the RIN 422 is communicated 430 to user 406, user 406 decides to accept the invitation of user 402. User 406 uses any of his PDC devices (e.g. computer 426) to contact the MyNet Broker 202 and notify it that he desires to respond to an invitation, as represented by path 428. As part of this communication 428, device 426 sends the RIN 422 to the MyNet Broker 202, thereby identifying the invitation 428 that user 406 received from user 402.

If the MyNet Broker 202 finds an entry in its internal invitations database that matches RIN 422 supplied by device 426 in message 428, the Broker 202 responds (as represented by path 432) with a modified version of discovery record of user 402 that was sent by device 410. The Broker 202 replaces the overlay routing information in the original discovery record (sent via path 412) with that of the MRV 204. This will allow the rest of the P2P MyNet Introduction process to be routed through the MRV 204. If no entry corresponding to the RIN 422 supplied by device 426 is found, the Broker 202 terminates the process.

Device 426 proceeds with the P2P MyNet Introduction process with device 416 over the overlay, as represented by path 434. The introduction messages are routed over the P2P overlay by the MRV 204. Before consenting to create a link to the PDC 408 of user 406 through device 426, device 410 requests authorization from the MyNet Broker 202, as represented by path 435. The Broker 202 checks to see if device 426 of user 406 has provided the correct RIN 422 and, if so, authorizes the linking process to complete. Devices 410 and 426 can then proceed to complete the P2P MyNet Introduction process as represented by path 436. Users 402 and 406 have now linked their PDCs 404, 408. MyNet P2P overlay traffic can be routed from and to their PDC devices, subject to the restrictions imposed by the MyNet Security framework.

The interactions involved in the Remote Introduction process shown in FIG. 4 can be summarized as follows:
A) MVD 416 registers with MyNet Broker 202 and sends to the Broker 202 the MVD's discovery record. Broker 202 replies with MyNet Rendezvous' (MRV) overlay routing info.
B) MVD's overlay router adds overlay route to MRV 416. This ensures P2P overlay traffic destined for MVD 416 can be later routed by MRV 204.
C) The user 402 uses one of his/her devices 418 to contact the MyNet Broker 202 and request for a remote invitation to be sent.
D) The MyNet Broker 202 creates a RIN 422 and sends it back to the device 418. The RIN 422 is sent to user 406 via out-of-band mechanism 430.
E) User 406 uses one of his/her devices 426 to send the RIN 422 to the MyNet Broker 202 and notify that he/she wants to respond to the invitation.
F) MyNet Broker 202 confirms the RIN 422 and responds with a modified discovery record for device 426 containing the MRV routing data.
G) Device 426 of user 406 proceeds with the P2P MyNet Introduction process with device 416 of user 102 via the MRV 204 based on the overlay.
H) Device 416 of user 402 requests authorization from the MyNet Broker 202 before proceeding with the Introduction process.
I) The Introduction process is completed; users 402 and 406 have now linked their PDCs 404, 408.

### MyNet-“aware” Internet Services

In another aspect of the present invention, special MyNet-“aware” applications running on user's MyNet devices. These applications act as MyNet-“aware” proxies of existing Internet Consumer Services. In reference now to FIG. 5, a block diagram shows an example of service applications according to an embodiment of the invention. In the illustrated embodiment, two services 502, 504 running on MVD 506. These and similar services 502, 504 may be referred to herein as MyNet-“aware” Internet Services. Even though such services 502, 504 could run on any devices of a users' PDC 508, MyNet-“aware” Internet Services are most likely to run on MVDs, which offer 24/7 availability and infrastructure-grade reliability;

Therefore, it may be assumed for simplicity that MyNet-“aware” Internet Services 502, 504 run on MVD 506, although the services may run on other PDC devices, such as mobile phone 510 or laptop computer 512. MyNet-“aware” Internet Services 502, 504 are MyNet-“aware” distributed applications which interface with Internet Consumer Services 514 on one side, and the PDC 508 on the other side.

On the “Internet-side,” these services 502, 504 use whatever distributed interface these Internet Consumer Services 514 expose over the Internet 120. Examples of these interfaces include Web Services via Simple Object Access Protocol (SOAP), eXtensible Markup Language Remote Procedure Call (XML-RPC), plain Hypertext Transport Protocol (HTTP), etc. On the “MyNet-side”, these services 502, 504 translate these interfaces to appropriate MyNet Remote Procedure Calls (RPC), which are invoked by the user's client devices 508 over the MyNet P2P overlay network.

The MyNet-“aware” Internet Services 502, 504 appear to the user similar to any other regular MyNet distributed application (e.g., music player, digital camera) running on his/her other PDC personal devices. Because they are MyNet-“aware” (i.e. written using the MyNet API), they take full advantage of MyNet's unique features, such as the MyNet service management, security, and intuitive UI interaction frameworks. A description of MyNet service management framework can be found in commonly-owned U.S. patent application Ser. No. 11/897,444 filed on Aug. 30, 2007 and entitled “Access Rights Used For Resource Discovery In Peer-To-Peer Networks.” (herein after referred to as “Access Rights” reference).

The MyNet service management framework is used to install the server-side and client-side components of the MyNet Internet Services by default or on user's demand. The MSP can customize the user experience for a particular service by customizing the client-side application used for user interaction, rather than necessarily use a Web-browser. For instance, the front-end application for a mobile phone will be designed differently from the front-end application of a laptop for the same service. The server-side of a MyNet Internet Service 502, 504 runs on an MVD 506, (e.g., on a device that is part of the user's PDC 508). Therefore the services 502, 504 have seamless and secure access to all of the user's personal devices, content and distributed applications, wherever they may reside in his/her PDC 508, as soon as they are created. Furthermore, the user can share selected functionality of MyNet Internet Services 502, 504 any of his/her social contacts in the same way as he/she shares any other of his personal resources.

Furthermore, MyNet Internet Services 502, 504 may in fact be composite services that combine functionality from more than one Internet Consumer Services providers 514. For example, a MyNet Internet Photo Service may offer a new service that ships photos printed from a Photo Printing online service on frames selected from another online retailer, while giving the user the illusion that he/she is using only one MyNet-“aware” Internet Service. This is shown in FIG. 5, where MyNet retail service 502 combines Internet retail services 516, 518.

In addition, MyNet-“aware” Internet Services 502, 504 may combine not only service components from different Internet Consumer Service providers 514, but also components from personal distributed applications running on the users' own devices. For example, the above-mentioned MyNet Photo Printing service could include a component that allows the user to print snapshots captured from live video in his/her Wi-Fi home camera. In another example, the music service 504 may seamlessly combine a catalog of streaming music available from online service 520 with music available from one or both PDC devices 510, 512. In this way, the user may have access to his/her entire music catalog plus the commercial offerings of service 520 regardless of which device 510, 512 is being used.

The combination of the elements described herein (i.e. Remote MyNet Introductions, MVDs, MyNet Internet Services), as well as the rest of MyNet's unique features give rise to a new business model that combines P2P personal devices, content, services and social interaction, with traditional centralized Internet Consumer Services. The MSP can offer a wide range of MyNet-“aware” Internet Services provisioned by itself or, through agreements, by 3rd party providers. The users will only need to add an MVD to their PDCs (e.g. motivated by some free online storage space, the ability to add social contacts remotely) and will gain access to a variety of MyNet-“aware” Internet Services that the MSP has chosen to provide.

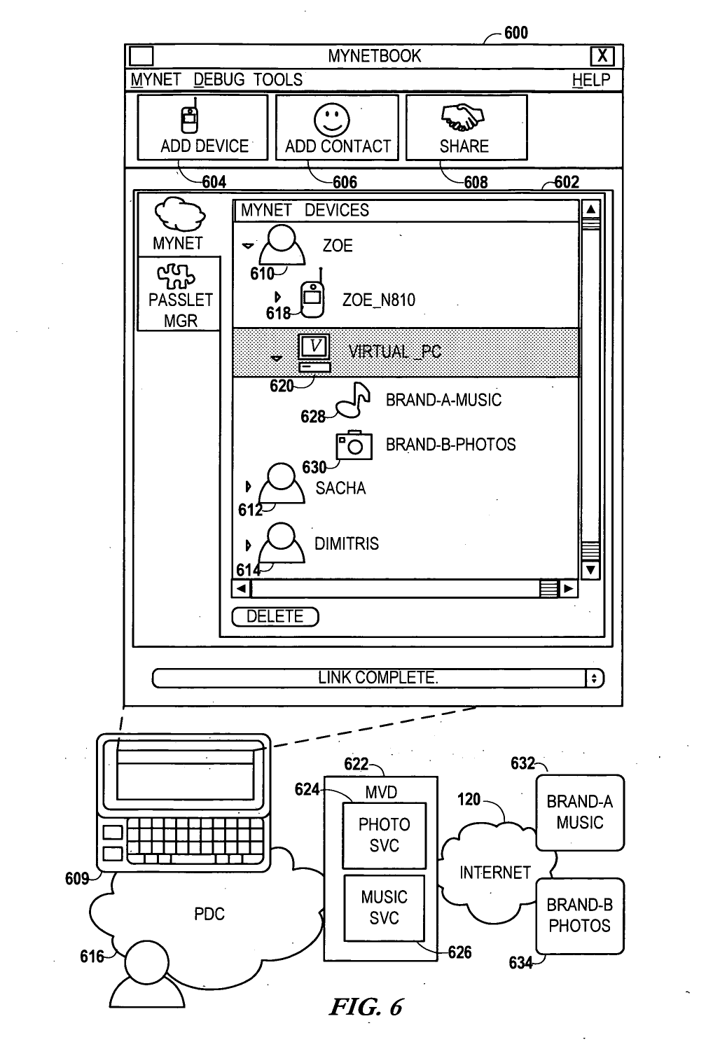

In order to provide a better understanding of concepts described herein, FIGS. 6-8 present example user interface screens according to embodiments of the invention. In the example MyNet implementations, the resource viewer component is referred to as MyNetBook. MyNetBook is the GUI interface of MyNet and can run on a MyNet-enabled device with a display. MyNetBook provides a number of tools that expose MyNet functionality to the end user. In FIG. 6, resource viewer 600 includes a viewing pane 602 that visualizes various resources discovered and accessible to the user. Other controls include a network configuration control 604 that allows the user to specify various network and application layer settings of the application, such as network interfaces, media, addresses, protocols, P2P access mechanisms, encryption, etc., that relate to the underlying connectivity used for service discovery and other network functions. An “add contact” control 606 allows the user to add new contacts, both for purposes of sharing content with that contact and for accessing content offered by that contact. A sharing control 608 manages aspects of sharing content, including global settings and contact specific settings.

Device 609, which belongs to user Zoe, is running the viewer user interface 600. Zoe is represented in the viewer 600 by icon 610. Other users with which Zoe has a sharing relationship can be seen by way of icons 612, 614. These icons 612, 614 denote Sacha and Dimitris, respectively, as belonging to Zoe's personal MyNet space. The devices of Zoe's PDC 616 are displayed below Zoe's personal icon 610. In this example, Zoe has a physical device represented by icon 618, and virtual computer represented by icon 620. The services of the virtual computer 620 are provided by MVD component 622.

The MVD 622 provides a photo service 624 and music service 626, respectively. These services 624, 626 are represented by icons 628, 630 under the virtual PC icon 620. The underlying content and services accessed by way of the icons 628, 630 may be provided, at least in part, by Internet services 632, 634. It will be appreciated that these icons 628, 630 appear and act similar to other icons of the viewing pane 602, thus the user need not know or care that the content/services are provided locally or remotely. Similarly, these service interfaces 624, 626 may be shared with other users 612, 614 using the same MyNet techniques used to share locally generated content via the PDC 616.

In reference now to FIG. 7, user interface diagrams illustrate how a user may register for a virtual computing resource according to embodiments of the invention. The user selects the “Add Device” button 704 on MyNetBook interface screen 702. In response, a dialog 706 appears that gives the user a number of options. For adding physical devices, the user is presented with controls 708, 710 which respectively allow adding a device through proximity detection and network discovery. A third control 712 allows a virtual device to be added.

In response to selecting control 712, a dialog 714 is presented to the user. The screen 714 includes an image 716 and text entry box 718. The image 716 may be automatically generated by the MyNet Broker (e.g., Broker 202 in FIG. 2). The image 716 includes a code (e.g., a number) with additional features that prevent an optical character recognition (OCR) program from reading the code. A human can read the code contained in the image 716, and therefore types the code into the entry box 718. In this way, the Broker ensures that such addition of a virtual device cannot be made by a program (e.g., malware) without input from the targeted user.

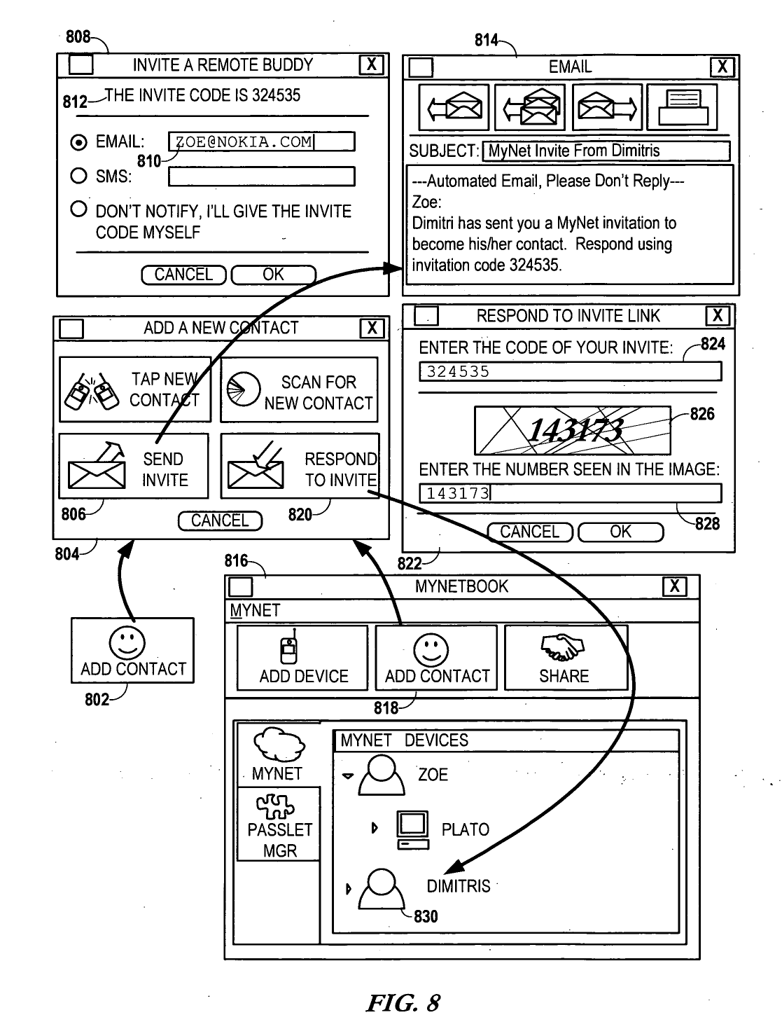

In response to user input in dialog 714, the user device displaying the viewer 702 will receive an update that the virtual device has been added. The addition is reflected in the viewer 702 by the addition of icon 720 underneath the user icon 722. Thereafter, the user can use this icon 722 to access the services, either internal or external, that are managed by the underlying MVD. The user can also invite other users to use the services of the MVD. In reference now to FIG. 8, user interface diagrams illustrate how a remote MyNet invitation is processed according to an embodiment of the invention.

In this example, Dimitris (the user associated with the scenario describe in FIG. 7) wishes to add Zoe as a contact. Dimitris will select the add contact button 802 of a viewer interface (e.g., interface 702 in FIG. 7) which causes dialog 804 to be displayed. From this dialog 804, Dimitris selects control 806 which causes dialog 808 to appear. Dialog 808 gives a number of options for communicating the invitation, including email, Short Message Service (SMS) or some other communication. In this example the email is selected, and the target address filled into text entry box 810. Note that information text 812 informs Dimitris of the invitation code to be used should an alternate (e.g., verbal) invitation method be used.

It will be appreciated that other confirmation techniques instead of or in addition to the invitation code 812 may be used. For example, Dimitris may be able to select and/or form a personal question that both the invitee and inviter know, but would not be known by others (e.g., “What is the name of Dimitris' dog?,” “What is the last movie we saw together?”). This alternate confirmation data may be sent by any of the methods shown in dialog 808.

In response to selections made in dialog 808, a message 814 is sent to Zoe containing the invitation and confirmation data. From Zoe's own MyNetBook viewer 816, Zoe selects the “Add Contact” button 818 and is presented with dialog 804. Zoe selects control 820 and is presented with confirmation dialog 822. This dialog 822 includes a field 824 for entering the supplied invite code, and an image 826 and entry field 828 used to prevent automated confirmations. In response to successful confirmation via dialog 822, Zoe is able to see icon 830 which provides access to devices/services offered and allowed by Dimitri.

Among the advantages offered to the user by MyNet-“aware” Internet Services as describe above are: (a) ease-of-use, convenience, click-of-a-button user experience, because the MyNet P2P overlay makes sure that the MyNet-“aware” Internet Services have access to all of the user's personal resources; (b) optimized user-interaction through the use of MyNet-“aware” client-side applications to the MyNet Internet Services installed automatically or on demand to the user's personal PDC devices; (c) no need to register separately for every new MyNet Internet Service, one-stop shopping for a wide variety of Internet Consumer Services; and (d) social networking aspects, as users will be able to use MyNet's functionality to identify and give permissions (Passlets) to any of their social contacts to share functionality that is allowed by each MyNet-“aware” Internet Service.

As described above, an MSP may provide a P2P overlay to enable remote sharing of content and services to MyNet-“aware” distributed applications, such as through the use of MVDs. Once a user signs-up and adds an MVD to his secure MyNet PDC, the user will automatically gain access to a catalogue of MyNet-“aware” Internet Services that the MSP is offering (e.g. music, photos, games, social networking, online retail, etc.), either itself or through agreements with third-party service providers. In order to attract service providers to such a system, a framework for collecting revenue may be needed, such as a paid subscription model. In other arrangements, an advertisement and marketing framework may be integrated with P2P personal and social networks such as MyNet.

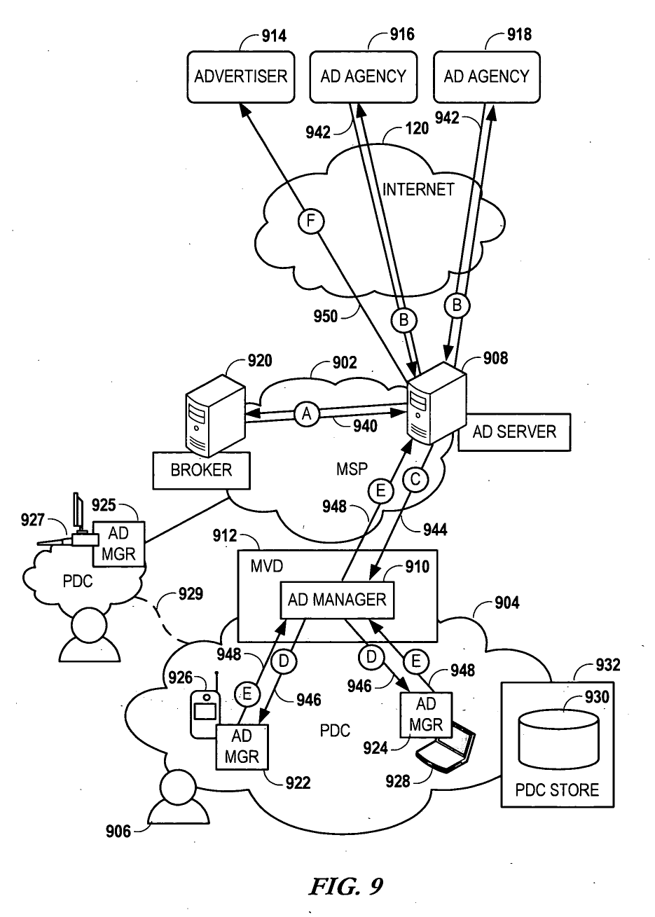

In reference now to FIG. 9, a block diagram shows features of a system that introduces advertisements that may be integrated with P2P social network frameworks as described herein. An MSP 902 offers MyNet-“aware” Internet Services and other services to the PDC 904 of user 906. The services of the MSP 902 may be supplemented with MyNet Advertisement, as indicated by the ad server 908 component of the MSP 902, and the ad manager component 910 of an MVD 912. The MSP 902 provides the ads according to arrangements with various advertisers 914 and ad agencies 916, 918 as will be described in greater detail below.

In one arrangement, if user 906 selects not to use any of the valued-added MSP services but use only the P2P aspects of MyNet, no advertisements will be received. However, if a user signs up for a free MVD 912, user devices 904 may display ads in the MyNet UI tools that the user uses to manage his/her personal and social network and browse/share their resources (e.g., ads may appear on MyNetBook viewer interface as shown in FIGS. 6-8). Other MyNet client-side applications may display ads as well. Ads can either be general MyNet ads or specific to each MyNet-“aware” Internet Service. The latter will correspond to the Service ID of certain MyNet-“aware” Internet Services. Service IDs are described in greater detail in the Access Rights reference.

Which and how many advertisements the user 906 will receive will depend on the level of service and pricing scheme that he/she has selected. For example, some users may select to pay full-price for a service, in which case they will receive no corresponding advertisements, while others may select to enjoy the service at a significant discount, in which case they will receive a stream of corresponding advertisements whenever they access that service. Furthermore, since MyNet maintains profile information about the users and their social contacts and groups, such information may also be used to provide more focused advertisement targeting. In either case, the MSP 902 includes safeguards to protect the privacy of all users.

An advertising system as described herein may include other features to ensure system security and integrity. For example, all MyNet Advertisements may be required to be digitally-signed by the MSP 902. Unsigned or incorrectly signed ads are deleted by the system before they are processed or displayed to the user. This will ensure protection of user and device privacy and prevention of malicious attacks (e.g., spamming, spyware, etc.).

Advertisements may also be provided as MyNet-“aware” light-weight applications, with access to certain MyNet middleware APIs. This will not only make them more interactive, but also allow them to leverage MyNet unique functionality. For example, a MyNet-“aware” ad may use a MyNet API that returns the number of social contacts/groups owned by the user and return this information to the MSP system 902. Such information may be valuable for billing purposes, especially for advertisers that rely on word of mouth or viral marketing and for whom a user with many social contacts may be more valuable. The MyNet APIs exposed for such purposes are designed to be safe and anonymous, and provide protection from abuse (e.g., never revealing personal information). As an additional protection, the MyNet advertising system will make this information anonymous. Again, the MSP 902 will include security measures that designed to safeguard the privacy of all users.

In addition to regular advertising messages, MyNet Advertisements may also include MyNet-“aware” marketing tools, through which the advertiser can get specific feedback from the user. Examples include surveys, focus groups, market-research, user-testing of new applications, etc. Furthermore, special MyNet Advertisements may have the form of invitations for the user to add the advertiser's PDC as a social link to the user's social network. This will allow the user and the advertiser to use MyNet to establish a relationship, though which the advertisers may offer the users some incentives that will allow them to increase customer awareness and/or brand loyalty. For example, the advertiser 914 may offer bonus content to users 906 who establish a social link with their PDC 904, sample or beta products, news about product launches, etc. Other advertising features that may be implemented in a P2P framework are described in greater detail below.

### MyNet Reward Points

The MSP 902 may provide users extra incentives to view certain ads, by offering them “MyNet reward points”. These points are a form of virtual currency that the users will be able to redeem to receive certain MyNet-“aware” Internet Services. For example, a user of the “MyNet Music Service” will be able to collect ten MyNet points every time he/she clicks on an ad appearing on her MyNet client-side music player application on any of his/her PDC devices 904, and will be able to use five hundred such MyNet points to purchase a song from the “MyNet Music Service” store.

MyNet Reward Points can also be awarded when the user makes use of MyNet-“aware” marketing tools. For example, if a user decides to take a survey contained in a MyNet Advertisement, he/she can gain five hundred points, as opposed to just ten for viewing the ad. Similar award increases can be provided when a user makes a purchase in response to a targeted ad. For example, a vendor and MSP may have an arrangement that the vendor will collect MyNet codes as part of a checkout procedure (e.g., the code may be entered in an existing promotional code entry box on the vendor's checkout Web page). When or after selecting an ad, the user is provided a special code by an MSP. Such code may be embedded in the ad, provided by way of an intermediary content page, or automatically entered based on persistent object (e.g., browser cookie). When the code is used during purchase, the vendor communicates the usage of the code back to the MSP, who awards the user the points. In this way, there is an incentive on the part of the user to explore and make purchases by way of the ads. There is also an incentive on the part of the vendor and MSP to provide these codes, as usage of the codes is an accurate indicator of the efficacy of the ads.

### MyNet Advertisement Server

The proposed invention introduces a MyNet Advertisement Server 908 as part of the MSP infrastructure as seen in FIG. 9. The advertisement server 908 is responsible for signing and distributing the ads submitted by the advertisers 914 and/or agencies 916, 918 to MyNet devices (e.g., PDC 904). The server 908 may also collect viewing and usage statistics to calculate billing and MyNet reward points information. The MyNet Advertisement Server may also contact a MyNet Broker 920 to collect extra information about the user 906 and his/her PDC 904 (e.g., profile information, usage info of MyNet-“aware” Internet Services, etc.). This will allow better targeting of the user 906 with relevant ads, thus increasing the value of the ads to the advertisers 914, 916, 918.

### MyNet Advertisement Manager

The system illustrated in FIG. 9 introduces a software component called the Advertisement Manager (AM) as part of the MyNet middleware. As previously mentioned, the AM 910 may be included in MVD 912, and AM components 922, 924 may be included in other devices 926, 928, respectively. One function of the AMs 910, 922, 924 are to subscribe and receive streams of MyNet advertisements from the MyNet Advertisement Server 908. This function may be performed by an AM in the user's personal device that hosts the server-side of the corresponding MyNet-“aware” Internet Service. Therefore, in one implementation, this function will be performed by the AM 910 in the user's MVD 912. The AM 910 may contact the MyNet Advertisement Server 908 to fetch the ads over public IP networks (e.g., the Internet 120) and not necessarily over the P2P overlay network.

The AM 910 of the device that hosts the server-side of the MyNet-“aware” Internet Service (e.g., MVD 912) propagates ads to the user's other PDC devices 904 over the P2P overlay. The AM 910 may do this by taking advantage of MyNet's PDC-wide replication mechanism. The AM 910 that received the ads from the MSP 902 adds them in an advertisement repository 930 of a local PDC-store 932. The MyNet PDC-wide replication mechanism then makes sure it is replicated across all PDC devices 904. In an alternative implementation, other PDC devices 926, 928 could retrieve the ads from the device 912 hosting the server-side of the MyNet-“aware” Internet service at the same time they retrieve content from that device 912. The former method gives the advantage that ads will be available at all user devices 904, even those that the user 906 has not yet used to access this service.

The AM 922, 924 of the devices 926, 928 that host the client-side of the MyNet-“aware” Internet Service (e.g., any of the user's personal devices) exposes an API to the MyNet-“aware” client-side application. Through this API, the client applications retrieve ads which are relevant to the MyNet-“aware” Internet Service that the user 906 is accessing with that client-side application. Since MyNet devices will have very different rendering capabilities (e.g. the user's 50″ plasma TV vs. his/her mobile phone), the AM 922, 924, which knows what type of device the local MyNet middleware runs on, customizes (e.g., resizes, compresses, reformats) the objects returned by the API calls to the client-side applications, to make them appropriate for display in the local device 926, 928.

The AM of the devices 922, 924 that host the client-side of the MyNet-“aware” Internet Service (i.e. any of the user's personal devices) contact the MyNet Advertisement Server 908 with information about which ads have been viewed by the user 906. Alternatively, the client devices 922, 924 may contact the device that hosts the server-side of the MyNet-“aware” Internet Service (e.g., MVD 912), which would collect information from all PDC devices 904 about ad viewing and may compile PDC-wide statistics that are sent to the MyNet Advertising Server 908. The MyNet Advertising Server 908 can compile this information and make it anonymous to protect the user's privacy. This information may be used, for example, for billing the advertisers 914, to calculate MyNet reward points for the user 906, to derive marketing information about user behavior patterns and user interests, etc.

The AM 910 of the MVD that hosts the server-side of the MyNet-“aware” Internet Service also sends ads to an AM 925 of another user's device 927 which has received permission (e.g., a Passlet) from the user 906 to access PDC 904 with a MyNet client-side application, as indicated by link 929. This can happen if that MyNet-“aware” Internet Service allows ad-sponsored sharing. In certain cases, MyNet-“aware” Internet Services may not only allow but even promote sharing, by giving the user MyNet reward points as an incentive every time a user's social contact accesses the service. This can be viewed as a form of revenue sharing with the user or simply as a way to promote viral marketing. As an example of the former, the “MyNet Photo Service” may award MyNet reward points for users whose social contacts order a print from the user's shared photo albums. As an example of the latter, the “MyNet Music Store” may award MyNet reward points for users whose social contacts stream sample clips from a new album the record label wants to promote.

An example scenario of how the advertising system operates is summarized as follows:
A) Ad server 908 gets profile info 940 about user 906 via broker 920.
B) Ad server 908 retrieves relevant ads 942 from external services 916, 918.
C) Ad server 908 distributes ads 944 to ad manager 910 of the MVD 912.
D) Ad manager 922, 924 of each device 926, 928 receives the ads 946 upon demand, or through replication via the PDC-store 930.
E) Each ad manager 922, 924 returns ad viewing statistics 948 to ad server 908.
F) Ad server 908 compiles viewing results, makes information anonymous, and sends billing information 950 to advertisers.

The MSP 902 has a strong incentive to offer to MyNet user 906 MVD 912 (even for free), so that the MSP 902 can use the MVD 912 to lead user 906 to fee-based premium MyNet-“aware” Internet Services. Since MVD 912 consumes resources (processing power, hardware equipment, online storage, etc.), it is important for the MSP 902 to be able to derive advertisement revenues to offset the cost of the infrastructure. Furthermore, a MyNet-“aware” advertisement framework would allow the MSP 902 to offer MyNet-“aware” Internet Services at more competitive prices, some of them even for free. Therefore, there are clear benefits in introducing a MyNet-“aware” advertisement framework on top of the MyNet hybrid P2P/Internet Services platform.

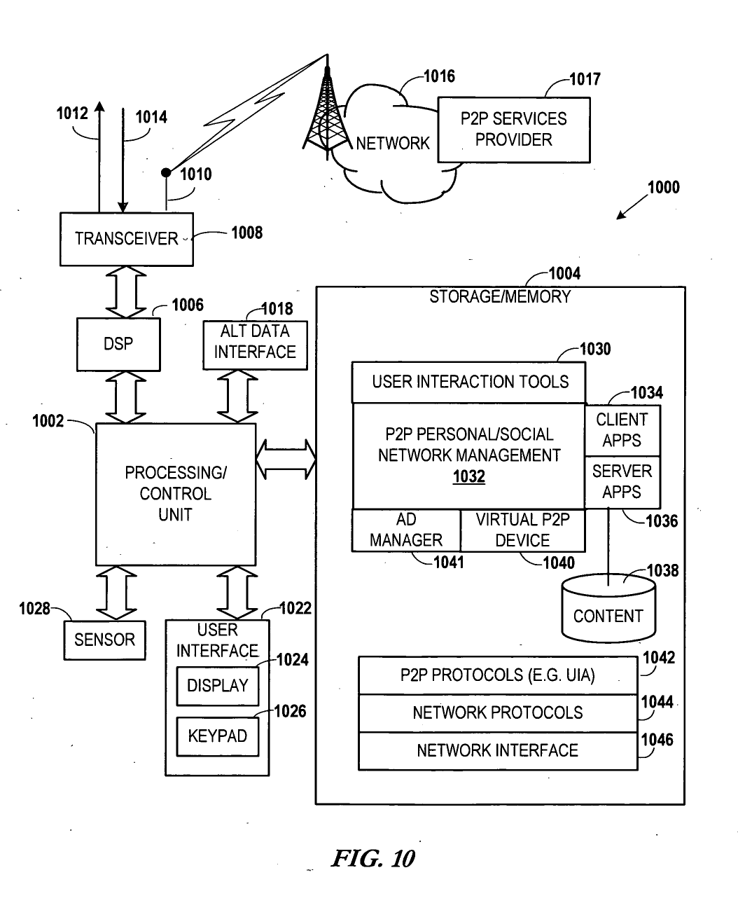

Many types of apparatuses may be able to participate in personal and social networks as described herein. Mobile devices are particularly useful in this role. In reference now to FIG. 10, an example is illustrated of a representative mobile computing arrangement 1000 capable of carrying out operations in accordance with embodiments of the invention. Those skilled in the art will appreciate that the mobile computing arrangement 1000 is merely representative of general functions that may be associated with such mobile devices, and also that landline computing systems similarly include computing circuitry to perform such operations.

The processing unit 1002 controls the basic functions of the arrangement 1000. Those functions associated may be included as instructions stored in a program storage/memory 1004. In one embodiment of the invention, the program modules associated with the storage/memory 1004 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 1000 via data signals, such as being downloaded electronically via one or more networks, such as the Internet and an intermediate wireless network(s).

The mobile computing arrangement 1000 includes hardware and software components coupled to the processing/control unit 1002 for performing network data exchanges. The mobile computing arrangement 1000 may include multiple network interfaces for maintaining any combination of wired or wireless data connections. In particular, the illustrated mobile computing arrangement 1000 includes wireless data transmission circuitry for performing network data exchanges.

This wireless circuitry includes a digital signal processor (DSP) 1006 employed to perform a variety of functions, including analog-to-digital (A/D) conversion, digital-to-analog (D/A) conversion, speech coding/decoding, encryption/decryption, error detection and correction, bit stream translation, filtering, etc. One or more transceivers 1008, generally coupled to one or more antennas 1010, transmits the outgoing radio signals 1012 and receives the incoming radio signals 1014 associated with the wireless device. Further, the mobile computing arrangement 1000 may include one or more digital or audio broadcasting receivers, such as digital audio, such Digital Audio Broadcast (DAB), digital TV, MediaFLO, Digital Video Broadcast—Handheld (DVB-H), Digital Multimedia Broadcast (DMB), Multimedia Broadcast Multicast Service (MBMS), etc.

The incoming and outgoing radio signals 1012, 1014 are used to communicate with a network 1016. The network 1016 may include any voice and data communications infrastructure known in the art, including CDMA, W-CDMA, GSM, EDGE, etc. The network 1016 provides access to traditional landline data infrastructures, including IP networks such as the Internet. In particular, the network 1016 hosts a P2P services provider 1017 that extends the functionality of a local P2P network that provides sharing of resources based on user-defined social and personal relationships. The mobile computing arrangement 1000 may also include an alternate network/data interface 1018 capable of accessing the network 1016 and/or a proximity network (not shown). The alternate data interface 1018 may incorporate combinations of I/O and network standards such as USB, Bluetooth, Ethernet, 802.11 Wi-Fi, IRDA, Ultra Wide Band (UWB), Wimax, Wibree, etc.

The processor 1002 is also coupled to user-interface elements 1022 associated with the mobile terminal. The user-interface 1022 of the mobile terminal may include, for example, a display 1024 such as a liquid crystal display. Other user-interface mechanisms may be included in the interface 1022, such as keypads 1026, speakers, microphones, voice commands, switches, touch pad/screen, graphical user interface using a pointing device, trackball, joystick, etc. One or more sensors 1028 may also be coupled to the processor 1002 for purposes such as capturing content. These and other external interface components are coupled to the processor 1002 as is known in the art.

The program storage/memory 1004 includes operating systems and programs for carrying out functions and applications associated with functions on the mobile computing arrangement 1000. The program storage 1004 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 1004 of the mobile computing arrangement 1000 may also include software modules for performing functions according to embodiments of the present invention.

In particular, the program storage/memory 1004 may include any combination of resource sharing components as described in greater detail above in relation to FIG. 1, such as user interaction tools 1030 and personal/social network management module 1032. The memory 1004 also may include client applications 1034 and server applications 1036 that interact with the management module 1032 for sharing resources with other user devices. The server application 1036 may make local computing resources available such as processing services and/or locally stored/created content 1038.

The functional modules of the arrangement 1000 enable peer-to-peer sharing of resources to selected individuals. In addition, a module 1040 that acts as virtual P2P device may be installed to interact with network resources, such as provided by services provider 1017. The module 1040 may include data and/or instructions that allow services of provider 1017 as being presented as a local device with services that are modeled analogously to other local P2P services (e.g., streaming music, photo sharing, etc.). As described above, most or all of the functionality of the module 1040 is commonly provided by the services provider 1017 (e.g., via an MVD). In such a case, the functionality of the virtual P2P device 1040 may be realized by existing functionality of the management software 1032 and UI tools 1030, where such functionality is used to interact with local devices of a personal P2P network.

The arrangement may also contain functional modules that provide an advertising interface with the various P2P modules 1030, 1032, 0134, 1036. This is represented by advertising module 1041, which may be optionally included as a resident client or server application. In some arrangements, the advertising module 1041 may be enabled to display advertising via user interaction tools 1030 and applications 1034, 1036. The module 1041 may also be able to collect usage and viewing data from these same components 1030, 1034, 1036, and provide such feedback data to infrastructure components (e.g., provider 1017) via network 1016.

The memory 1004 may include one or more P2P protocol stacks 1042 for facilitating P2P communications (e.g., ad-hoc connectivity, service discovery, service utilization). The P2P protocols 1042 may rely on a standard networking protocol stack 1044 for common network protocols such as TCP/IP, UDP/IP, etc. The network protocol stack 1044 in turn utilizes a network interface 1046 for accessing the network(s) 1016. The network interface 1046 may include a combination of hardware and software components, including media access circuitry, drivers, programs, and media access protocol modules.

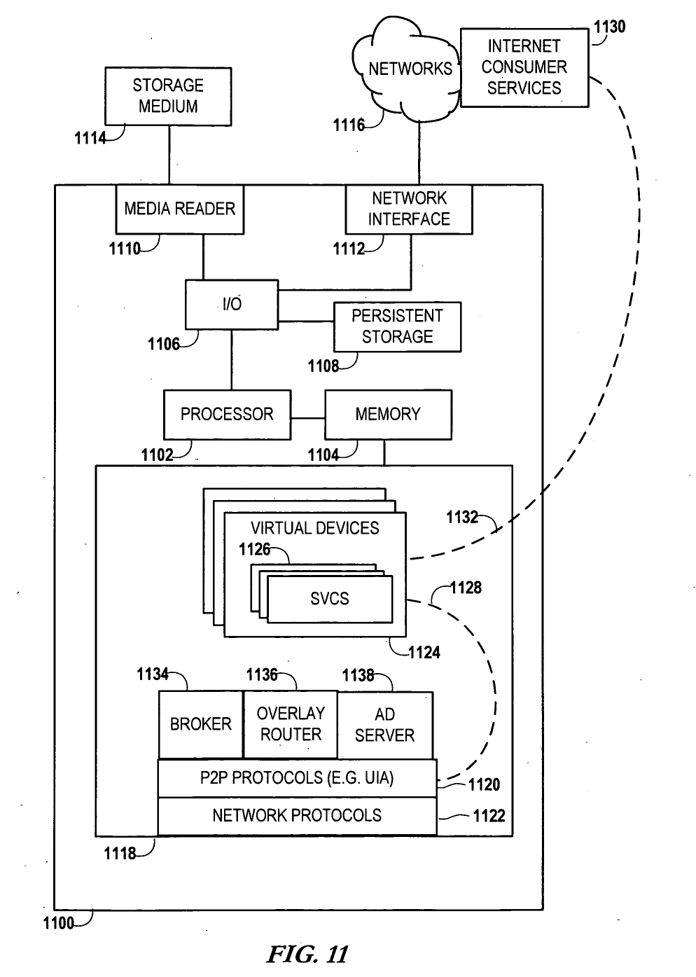

It will be appreciated that some of the adaptations above rely on various fixed infrastructure components to provide functions of virtual P2P devices. In reference now to FIG. 11, a block diagram illustrates an apparatus 1100 that may perform any combination of infrastructure functions according to embodiments of the invention. The apparatus 1100 may include a processor 1102, memory 1104, and an I/O bus 1106 that couples peripheral devices to the processor 1102. Those peripheral devices may include persistent memory storage 1108 (e.g., disc drives, flash memory), one or more network interfaces 1112, and a media reader 1110 (e.g., tape reader, floppy drive, Compact Disc player, Digital Versatile Disc player, memory card reader, etc.). The media reader 1110 is capable of reading from a storage medium 1114, such as optical or magnetic media. The media reader 1110 may also be capable of writing to the media 1114. The network interfaces 1112 may be capable of communicating via one or more networks 1116. The networks 1116 may utilize such media such as phone lines, coaxial cable, Ethernet, wireless radio transmissions, infrared transmissions, etc. The networks 1116 may include Internet Protocol (IP) based public and private networks, as well as proximity networking such as Bluetooth and IrDA.

The operation of the processor 1102 is dictated by instructions 1118 that may be stored temporarily or permanently in memory 1104 or other logic circuitry. The instructions 1118 may be built into to the apparatus 1100 during manufacture, or may be later transferred to the apparatus 1100 via the storage media 1114 or the networks 1116. The instructions 1118 include one or more P2P protocol stacks 1120 for facilitating communications with user-formed P2P groups using architectures such as UIA. The P2P protocols 1120 may rely on a standard networking protocol stack 1122 for common network protocols such as TCP/IP, UDP/IP, etc. The network protocol stack 1122 in turn utilizes the network interface 1112 for accessing the network(s) 1116.

The instructions 1118 may be capable of providing a plurality of virtual devices 1124 that appear as actual devices in a P2P social networking viewer such as the MyNet framework described above. The virtual devices 1124 may in turn make one or more services 1126 available to the user via the P2P network, as represented by path 1128. The services 1126 may be provided via the apparatus 1100, affiliated devices of the provider of the virtual devices 1124, and/or independent Internet consumer service providers 1130. Generally, the virtual devices 1124 and associated services 1126 may act as a bridge between the wide-variety of independent providers 1130 and the specific users and devices using the P2P protocols 1120, as represented by paths 1128 and 1132.

The instructions 1118 may also provide other infrastructure services as describe in greater detail hereinabove. In particular, a broker module 1134 may provide secure communications with a trusted centralized host of the service provider that provides the virtual devices 1124. An overlay router component 1136 may manage routing overlays that allows external entities to access the virtual devices 1124 which may be behind a Network Address Translation (NAT) firewall when being utilized in a local P2P environment. An ad server component 1138 may provide advertising materials and collect, aggregate, and anonymize usage data. The ad services component 1138 may be implemented to interact with clients via a virtual device 1124 or may directly use local application APIs of the P2P framework that manage content and services on user devices.

The apparatus 1100 may include other well-known features that are not illustrated, such as user input devices, user output devices, power circuitry, sensors, etc. As will be appreciated by one of skill in the art, an apparatus having the functions described herein may include a combination of two or more physical devices that are at least coupled via some data transfer medium to form a distributed computing arrangement. In other arrangements, the functions of various components represented by computing instructions 1118 can be separated to operate via dependently or independently operating computing arrangements coupled by networks. For example, each function of broker 1134, overlay router 1136 and ad server 1138 can each be separately implemented in physically dispersed apparatus that intercommunicate as described herein, but otherwise operate independently of each other.

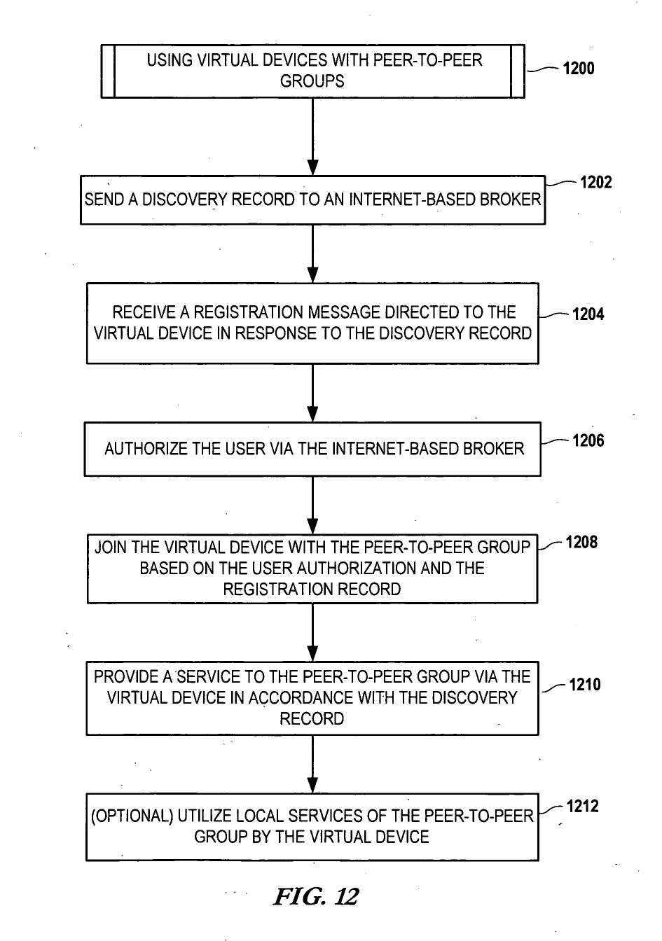

In reference now to FIG. 12, a flowchart illustrates a procedure 1200 for using virtual devices with P2P groups according to an embodiment of the invention. A discovery record is sent 1202 from a virtual device to an Internet-based broker. The discovery record is configured for use in a peer-to-peer group that comprises a plurality of devices of a user that are accessed based on decentralized permissions that collectively govern access to the plurality of devices. The virtual device includes a wide-area network service that is modeled to act as a physical device of the peer-to-peer group.

A registration message from the peer-to-peer group is received 1202 by the virtual device in response to the discovery record. The registration message is used to join the virtual device with the peer-to-peer group. The user is authorized 1206 via the Internet-based broker and the virtual device is joined 1208 with the peer-to-peer group based on the user authorization 1206. Services are then provided 1210 to the peer-to-peer group via the virtual device. Optionally, local services of the peer-to-peer group are utilized 1212 by the virtual device.

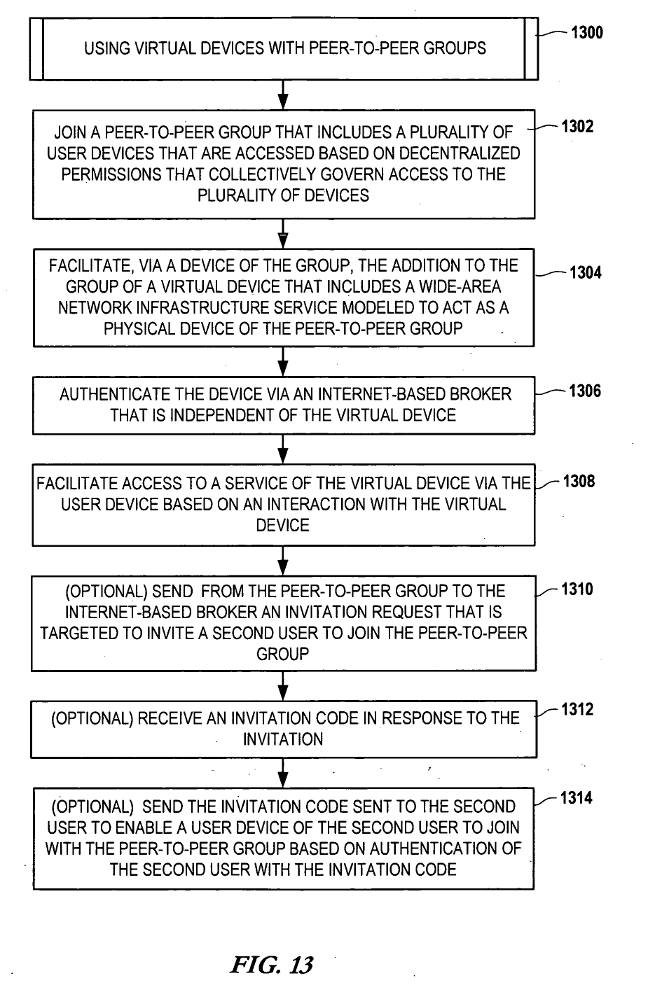

In reference now to FIG. 13, a flowchart illustrates another procedure 1300 for using virtual devices with P2P groups according to an embodiment of the invention. A user (e.g., via a user device) joins 1302 a peer-to-peer group that includes a plurality of devices of the user that are accessed based on decentralized permissions that collectively govern access to the plurality of devices. The addition of a virtual device to the peer-to-peer group is facilitated 1304 via a user device of the group. The virtual device includes a wide-area network infrastructure service that is modeled to act as a physical device of the peer-to-peer group. The user device is authenticated 1306 via an Internet-based broker that is independent of the virtual device, and access to a service of the virtual device is facilitated 1308 via the user device based on an interaction with the virtual device.

Optionally, the procedure may also involve sending 1310 an invitation from the user device to the Internet based broker. The invitation request is targeted to invite a second user to join the peer-to-peer group. An invitation code is received 1312 in response to the invitation, and the invitation code is sent 1314 to the second user to enable a user device of the second user to join with the peer-to-peer group based on authentication of the second user with the invitation code.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
sending a discovery record to an Internet-based broker;
receiving a registration message directed to a virtual device in response to the discovery record;
authorizing a peer-to-peer group of devices to utilize the virtual device via the Internet-based broker;
joining the virtual device with the peer-to-peer group based on the registration message and the authorization; and
providing a service to the peer-to-peer group via the virtual device in accordance with the discovery record.

2. The method of claim 1, wherein the peer-to-peer group comprises one or more devices of a user that are accessed based on decentralized permissions that collectively govern access to the one or more devices, and wherein the virtual device comprises a wide-area network service that is modeled to act as a physical device of the peer-to-peer group.

3. The method of claim 1, wherein the registration message is directed to the virtual device in response to the discovery record, wherein the registration message includes security information used in authorizing the peer-to-peer group.

4. The method of claim 1, wherein the discovery record is modified with routing data that enables Internet access to the virtual device.

5. The method of claim 4, wherein the modified discovery message is sent to the peer-to-peer group from the Internet-based broker.

6. The method of claim 4, wherein the routing data includes an address of a routing server that maintains route mappings for a plurality of virtual devices.

7. The method of claim 4, wherein the routing data enables access to the virtual device through a network firewall.

8. The method of claim 1, wherein the services provided via the virtual device comprises an Internet service of a third party that is independent of the peer-to-peer group and a provider of the virtual device.

9. The method of claim 8, wherein the Internet service comprises an advertising service that delivers advertising to the peer-to-peer group.

10. The method of claim 8, wherein a plurality of Internet services are presented as a single service of the virtual device.

11. The method of claim 1, further comprising utilizing local services of the peer-to-peer group by the virtual device.

12. The method of claim 1, further comprising:
sending an invitation request from the peer-to-peer group to the Internet-based broker, wherein the invitation request is targeted to invite a second user to join the peer-to-peer group;
receiving an invitation code in response to the invitation;
sending the invitation code to the second user;
authenticating the second user via the Internet-based broker based on the invitation code;
joining a user device of the second user with the peer-to-peer group based on authentication of the second user.

13. An apparatus comprising:
a network interface capable of Internet communications with a peer-to-peer group of devices;
a processor coupled to the network interface; and
memory coupled to the processor, the memory comprising instructions that cause the processor to:
send a discovery record to an Internet-based broker;
receive a registration message directed to the virtual device in response to the discovery record;
authorize, via the Internet-based broker, a peer-to-peer group of devices to utilize the virtual device;
join the virtual device with the peer-to-peer group based on the registration message and the authorization; and
provide a service to the peer-to-peer group via the virtual device in accordance with the discovery record.

14. The apparatus of claim 13, wherein the peer-to-peer group comprises one or more devices of a user that are accessed based on decentralized permissions that collectively govern access to the one or more devices, and wherein the virtual device comprises a wide-area network service that is modeled to act as a physical device of the peer-to-peer group.

15. The apparatus of claim 13, wherein the registration message is directed to the virtual device in response to the discovery record, wherein the registration message includes security information used in authorizing the peer-to-peer group.

16. The apparatus of claim 13, wherein the discovery record is modified with routing data that enables Internet access to the virtual device.

17. The apparatus of claim 16, wherein the routing data enables access to the virtual device through a network firewall.

18. The apparatus of claim 13, wherein the services provided via the virtual device comprises one or more Internet services of a third party that is independent of the peer-to-peer group and a provider of the virtual device.

19. The apparatus of claim 18, wherein the Internet service comprises an advertising service that delivers advertising to the peer-to-peer group.

20. An apparatus comprising:
a network interface capable of communicating with a peer-to-peer group;
a processor coupled to the network interface; and
memory coupled to the processor, the memory comprising instructions that cause the processor to:
join the apparatus to the peer-to-peer group;
facilitate the addition of a virtual device to the peer-to-peer group, wherein the virtual device comprises an Internet-based service that is modeled to act as a physical device of the peer-to-peer group;
authenticate the apparatus for access to the virtual device via an Internet-based broker that is independent of the virtual device; and
access a service of the virtual device.

21. The apparatus of claim 20, wherein the peer-to-peer group comprises one or more devices of a user that are accessed based on decentralized permissions that collectively govern access to the plurality of devices.

22. The apparatus of claim 20, wherein the instructions further cause the processor to:
send an invitation request to the Internet-based broker, wherein the invitation request is targeted to invite a second user to join the peer-to-peer group; and
receive an invitation code in response to the invitation, wherein the invitation code is sent to the second user to enable a user device of the second user to join with the peer-to-peer group based on authentication of the second user with the invitation code.

23. A computer readable storage medium having instructions stored thereon executable by a processor to:
send a discovery record from a virtual device to an Internet-based broker;
receive a registration message directed to the virtual device in response to the discovery record;
authorize a peer-to-peer group to utilize the virtual device via the Internet-based broker;
join the virtual device to the peer-to-peer group based on the registration message and the authorization; and
provide a service to the peer-to-peer group via the virtual device.

24. An apparatus comprising:
means for engaging in communications with a peer-to-peer group; and
a virtual device module comprising:
means for sending a discovery record to an Internet-based broker;
means for receiving a registration message directed to the virtual device in response to the discovery record;
means for authorizing, via the Internet-based broker, a peer-to-peer group to utilize the virtual device;
means for joining the virtual device to the peer-to-peer group based on the user authorization; and
means for providing a service to the peer-to-peer group via the virtual device in accordance with the discovery record.

25. The apparatus of claim 24, further comprising means for utilizing local services of the peer-to-peer group by the virtual device.
